(19) United States
(12) Patent Application Publication
(10) Pub. No.: US 2022/0330706 A1
(43) Pub. Date: Oct. 20, 2022

(54) Supporting Mechanism and Electric Bed Frame Applying the Mechanism

(71) Applicant: Hangzhou Dacheng Film Media Co., Ltd., Hangzhou (CN)

(72) Inventor: Weishuo Chen, Hangzhou (CN)

(21) Appl. No.: 17/356,514

(22) Filed: Jun. 24, 2021

(30) Foreign Application Priority Data
Apr. 14, 2021 (CN) 202110401750.X

(51) Int. Cl. A47C 20/04

(52) U.S. Cl. CPC A47C 20/041

(57) ABSTRACT

The present application relates to a supporting mechanism and an electric bed frame applying the mechanism, which includes a first electric cylinder, a connecting rod, a supporting plate and two fixed frames. Both ends of the first electric cylinder are respectively rotatably connected to the connecting rod and one of the fixed frames; the two fixed frames each are rotatably connected with a rotatory frame, and the connecting rod is connected to the two rotatory frames; the two rotatory frames each are rotatably connected with a roller and a linkage frame, the roller abuts against the supporting plate, and the two linkage frames each are respectively rotatably connected to the supporting plate; the rotation planes formed by the first electric cylinder, by the rotatory frame and by the linkage frame when rotating are parallel to each other. The present application can improve the comfort of a user.

### CROSS REFERENCE TO RELATED APPLICATIONS

This application claims priority to Chinese Patent Application No. 202110401750.X, filed on Apr. 14, 2021. The entirety of the above-mentioned patent application is hereby incorporated by reference herein and made a part of this specification.

### TECHNICAL FIELD

The present application relates to the technical field of a bed frame, in particular to a supporting mechanism and an electric bed frame applying the mechanism.

### BACKGROUND

A bed frame is a frame of a bed.

The inventor found that the current bed frame on the market cannot fit a user's waist well, causing the user's waist to hang, which affects the user's comfort when using the bed frame, and therefore it is needed to be improved.

### BRIEF SUMMARY

In order to improve the comfort of the user, the present application provides a supporting mechanism and an electric bed frame applying the mechanism.

In the first aspect, a supporting mechanism provided by the present application adopts the following technical solutions. A supporting mechanism comprises a first electric cylinder, a connecting rod, a supporting plate and two fixed frames, wherein both ends of the first electric cylinder are respectively rotatably connected to the connecting rod and one of the fixed frames; the two fixed frames each are rotatably connected with a rotatory frame, and the connecting rod is connected to the two rotatory frames; the two rotatory frames each are rotatably connected with a roller and a linkage frame, the roller abuts against the supporting plate, and the two linkage frames each are respectively rotatably connected to the supporting plate; the rotation planes formed by the first electric cylinder, by the rotatory frame and by the linkage frame when rotating are parallel to each other.

By adopting the above technical solution, when a piston rod of the first electric cylinder extends out, the first electric cylinder itself will rotate and cause the connecting rod to move. The connecting rod when moving will drive the two rotatory frames to rotate, the rotatory frame when rotating will drive the linkage frame to rotate, and the linkage frame will drive the supporting plate to move, so that the supporting plate abuts against the user's waist and realizes the support of the user's waist, thereby improving the user's comfort. In addition, the end of the first electric cylinder rotatably connected to the fixed frame can also be directly rotatably connected to a bed plate of an electric bed frame.

During the rotation of the rotatory frame and the linkage frame, the roller on the rotatory frame will always abut against the side of the supporting plate away from the user's waist, and realizes the support of the supporting plate and improves the stability of the supporting plate when supporting the user's waist. Compared with a structure in the current market in which an electric cylinder directly drives a connecting frame to rotate so as to prompt a supporting plate on the connecting frame to flip, in the present application, the end of the supporting plate, the fixed frame, the rotatory frame and the linkage frame will jointly form one set of approximately linear assemblies, and the connecting rod will connect the two sets of approximately linear assemblies, making one set of approximately linear mechanism in the present application; the two sets of approximate linear assemblies driven by the piston rod of the first electric cylinder will push the supporting plate straightly to make the supporting plate move upwards approximately in a straight line. At this time, the supporting plate will not be easy to rub against the bed frame. During the movement of the supporting plate, the movement of the first electric cylinder in the vertical direction is small, and the connecting rod in the present application is located at the upper end of the linear assemblies, which makes the supporting mechanism more compact and occupy a smaller space so as to be convenient to mount other structures near the supporting structure, and reduces the overall height of the bed frame.

In the second aspect, an electric bed frame provided by the present application adopts the following technical solutions. An electric bed frame comprises a bed frame body and at least one group of the supporting mechanism, wherein the fixed frame is provided on the bed frame body, and a through slot is provided on the bed frame body for the corresponding supporting plate to slide through.

By adopting the above technical solution, when the user lies on the bed frame body, the first electric cylinder in the supporting mechanism will cause the supporting plate to slide in the through slot, so that the supporting plate can support the user's waist and improve the user's comfort.

Alternatively, the bed frame body includes a bed frame, an upper plate mechanism, a lower plate mechanism and a telescopic mechanism; at least one group of the supporting mechanism is provided on the upper plate mechanism, and the fixed frame in the supporting mechanism is mounted on the upper plate mechanism; at least one through slot is provided on the upper plate mechanism, the upper plate mechanism is rotatably connected to the lower plate mechanism, the lower plate mechanism is provided on the bed frame, and both ends of the telescopic mechanism are respectively rotatably connected to the bed frame and the upper plate mechanism.

Alternatively, the telescopic mechanism comprises a second electric cylinder, a connecting frame, a penetration rod and a rotatory plate; both ends of the second electric cylinder are respectively rotatably connected to the bed frame and the connecting frame, the connecting frame is connected to the penetration rod, the penetration rod extends in the horizontal direction through the rotatory plate, and both ends of the rotatory plate are respectively rotatably connected to the bed frame and the upper plate mechanism.

Alternatively, the upper plate mechanism comprises a backplate, a headplate and a third electric cylinder; both ends of the backplate are respectively rotatably connected to the lower plate mechanism and the headplate, and both ends of the telescopic mechanism are respectively rotatably connected to the bed frame and the backplate; at least one through slot is provided on the backplate, and both ends of the third electric cylinder are respectively rotatably connected to the backplate and the headplate.

Alternatively, the lower plate mechanism comprises a buttock plate, a leg plate unit and a fourth electric cylinder; both ends of the buttock plate are respectively rotatably connected to the upper plate mechanism and the leg plate unit, and both ends of the fourth electric cylinder are respectively rotatably connected to the bed frame and a leg plate unit.

Alternatively, the leg plate unit comprises a thigh plate and a calf plate; both ends of the thigh plate are respectively rotatably connected to the buttock plate and the calf plate, and both ends of the fourth electric cylinder are respectively rotatably connected to the bed frame and the thigh plate.

Alternatively, the bed frame and the calf plate are rotatably connected with the same piece of the first linkage plate.

Alternatively, the at least one group of the supporting mechanism is provided on the lower plate mechanism, and the lower plate mechanism is further provided with a through slot.

Alternatively, the bed frame body is provided with at least one mount groove, and a massager is provided within the mount groove.

### BRIEF DESCRIPTION OF THE DRAWINGS

FIG. 1 is a schematic structural diagram of a supporting mechanism in the present application embodiment;

FIG. 2 is a schematic structural diagram of a fixed frame, a rotatory frame, and a linkage frame in the present application embodiment;

FIG. 3 is a schematic structural diagram of an electric bed frame in the present application embodiment;

FIG. 4 is a schematic structural diagram of a bed frame in the present application embodiment;

FIG. 5 is a schematic structural diagram of a horizontal plate in the present application embodiment;

FIG. 6 is a schematic structural diagram of a bed frame and a lower plate mechanism in the present application embodiment;

FIG. 7 is a schematic structural diagram of a bed frame, an upper plate mechanism, and a telescopic mechanism in the present application embodiment;

FIG. 8 is a schematic structural diagram of an upper plate mechanism and a telescopic mechanism in the present application embodiment.

### DETAILED DESCRIPTION

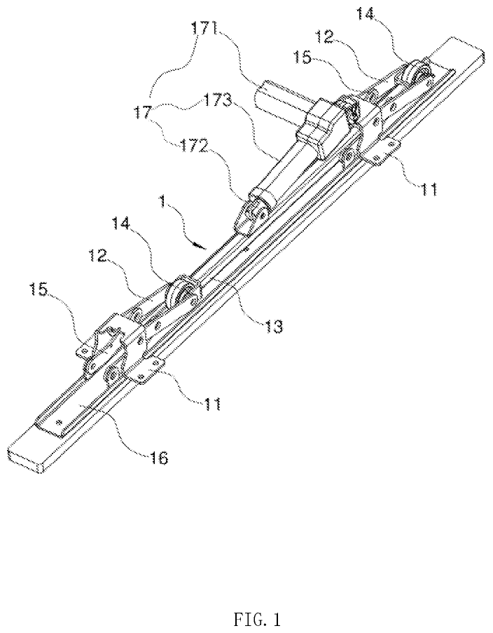

The present application will be described in further details below in conjunction with FIGS. 1-8.

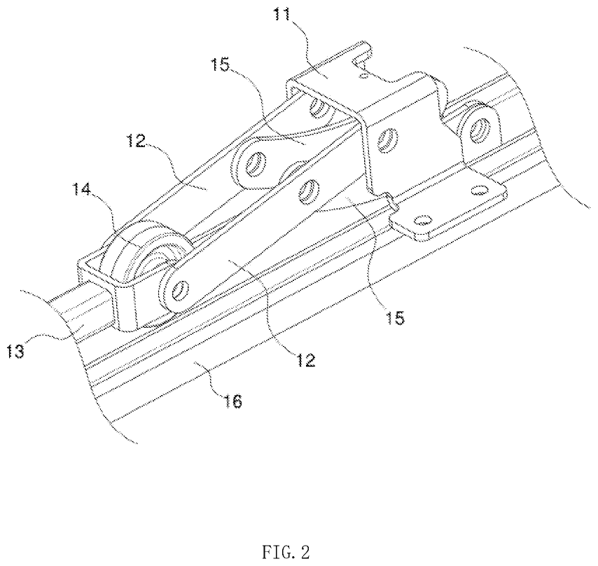

The present application embodiment discloses a supporting mechanism. As shown in FIGS. 1 and 2, a supporting mechanism 1 includes two fixed frames 11 to be mounted on a bed frame. The two fixed frames 11 each are rotatably connected with a rotatory frame 12, and the two rotatory frames 12 are fixedly connected with the same connecting rod 13. The two rotatory frames 12 each are rotatably connected with a roller 14 and a linkage frame 15. The two linkage frames 15 are rotatably connected with the same supporting plate 16. The two rollers 14 each abut against the supporting plate 16. One of the fixed frames 11 is provided with a first electric cylinder 17, and both ends of the first electric cylinder 17 are respectively rotatably connected to the connecting rod 13 and one of the fixed frames 11. The first electric cylinder 17 includes a screw rod 172, a servo motor 171 for driving the screw rod 172, and a sleeve 173 that is sleeved on the screw rod 172. One end of the screw rod 172 extends beyond one end of the sleeve 173. The end of the screw rod 172 extending out of the end of the sleeve 173 is rotatably connected to the connecting rod 13. The other end of the sleeve 173 is rotatably connected to one of the fixed frames 11. The rotation planes formed by the first electric cylinder 17, by the rotatory frame 12 and by the linkage frame 15 when rotating are parallel to each other.

When a piston rod of the first electric cylinder 17 extends out, the first electric cylinder 17 itself will rotate and cause the connecting rod 13 to move, the connecting rod 13 will drive the two rotatory frames 12 to swing, the two rotatory frames 12 will drive the corresponding linkage frame 15 to rotate, and the two linkage frames 15 will jointly drive the supporting plate 16 to move, so that the supporting plate 16 can move to abut against the user's waist, thereby improving the user's comfort.

During the movement of the supporting plate 16, the roller 14 on the rotatory frame 12 will roll on the supporting plate 16, and the roller 14 will support the supporting plate 16, so that the supporting plate 16 for supporting the user's waist is not easy to bend.

During the extension and contraction of the piston rod of the first electric cylinder 17, the first electric cylinder 17 itself will rotate slightly. One end of the first electric cylinder 17 rotatably connected to the fixed frame 11 has a small amount of vertical movement, while the piston rod of the first electric cylinder 17 will move synchronously with the connecting rod 13. Compared to directly using the first electric cylinder 17 to drive the supporting plate 16 to move in the vertical direction, the first electric cylinder 17 in the present application occupies a smaller space.

It should be noted that in this embodiment, the center distance of two rotating holes on the linkage frame 15 may be half of the center distance of rotating holes at the both ends of the rotatory frame 12, and a hole connected to the linkage frame 15 is located at the midpoint of the connection line between the two holes. At this time, the approximate linear mechanism may become a standard linear mechanism.

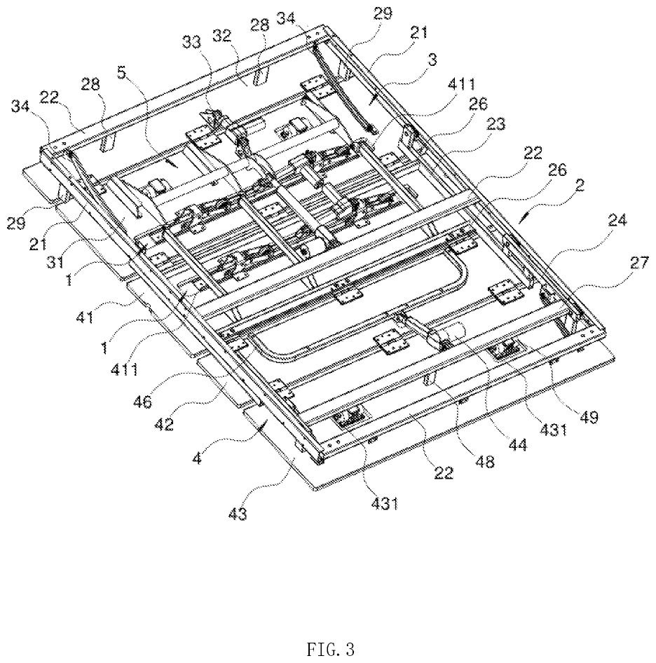

The present application embodiment also discloses an electric bed frame. As shown in FIG. 3, an electric bed frame includes a bed frame body and at least one group of the supporting mechanism 1. The bed frame body includes a bed frame 2, and the bed frame 2 is provided with an upper plate mechanism 3 and a lower plate mechanism 4. In this embodiment, the supporting mechanism 1 is set as two groups, and the two groups of the supporting mechanisms 1 are respectively located on the upper plate mechanism 3 and the lower plate mechanism 4 to realize the support of the user's waist and buttocks.

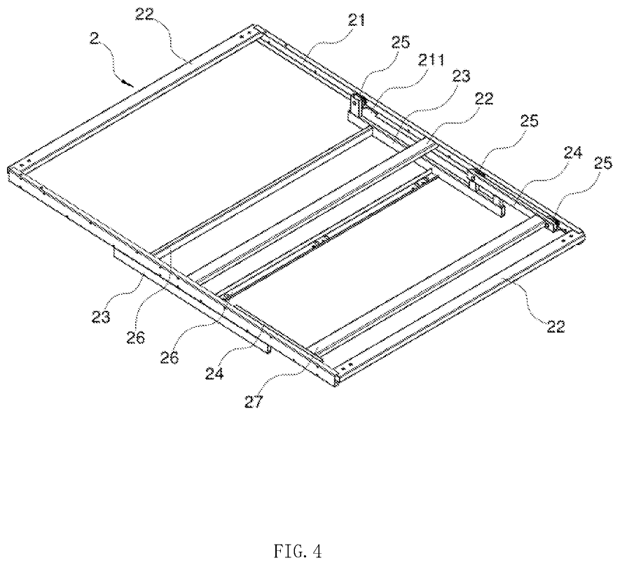

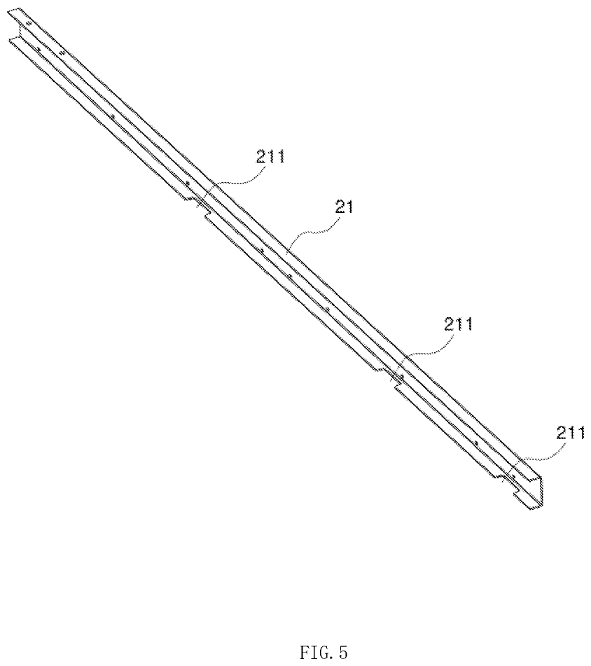

As shown in FIGS. 4 and 5, the bed frame 2 includes two horizontal plates 21, three longitudinal rods 22 located between the two horizontal plates 21, two first supporting rods 23 and two second supporting rods 24. The cross section of the horizontal plate 21 is C-shaped, and both ends of the longitudinal rod 22 are fixedly connected to the two horizontal plates 21 respectively. Three limit wheels 25 are rollably inserted in the cavity enclosed by each horizontal plate 21, wherein one of the limit wheels is rotatably connected to the corresponding the first supporting rod 23, and the other two limit wheels 25 are rotatably connected to the corresponding second supporting rod 24. The first supporting rod 23 is fixedly connected to the second supporting rod 24; the two first supporting rods 23 are connected by two first reinforcing rods 26; and the two second supporting rods 24 are connected by the same second reinforcing rod 27. There are three notches 211 on the horizontal plate 21, and a limit wheel 25 can enter through the notch 211 to the inside of the horizontal plate 21, thereby facilitating the assembly and disassembly of the limit wheel 25.

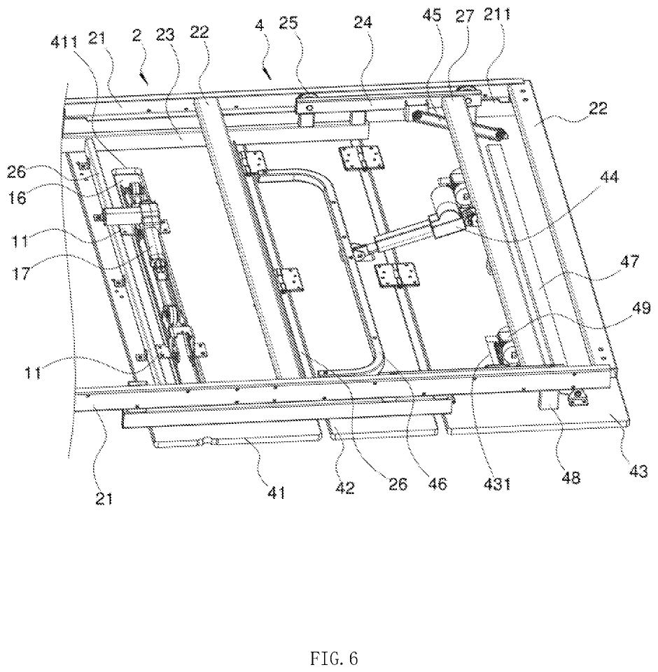

As shown in FIG. 6, the lower plate mechanism 4 includes a buttock plate 41, a leg plate unit and a fourth electric cylinder 44. The buttock plate 41 is fixed on the two first supporting rods 23 and the two first reinforcing rods 26. The leg plate unit includes a thigh plate 42 and a calf plate 43, and both ends of the thigh 42 are respectively rotatably connected to the buttock plate 41 and the calf plate 43. The both ends of the fourth electric cylinder 44 are respectively rotatably connected to the second reinforcing rod 27 and the thigh plate 42. The two second supporting rods 24 are rotatably connected with the first linkage plate 45, and the two first linkage plates 45 are rotatably connected to the calf plate 43.

When the user's buttocks are sitting on the buttock plate 41 and the piston rod of the fourth electric cylinder 44 extends out, the fourth electric cylinder 44 itself will rotate and cause the thigh plate 42 to rotate relative to the buttock plate 41, the thigh plate 42 during the rotation will drive the calf plate 43 to rotate, and the calf plate 43 during the rotation will drive the first linkage plate 45 to rotate; the thigh plate 42 and the calf plate 43 will form an inverted V-shaped plate, the user's thigh rests on the thigh plate 42, and the user's calf rests on the calf plate 43, the junction of the thigh plate 42 and the calf plate 43 will abut against the user's the bend between the thigh and the calf, which improves the user's comfort. The first linkage plate 45 can support the calf plate 43 to ensure the stability of the calf plate 43.

A first fixing rod 46 arranged in a U-shape is fixed on the thigh plate 42, which makes the thigh plate 42 difficult to be bent. A second fixing rod 47 extending in the horizontal direction is fixed on the calf plate 43, which makes the calf plate 43 difficult to be bent.

Three first top rods 48 are fixed on the second reinforcing rod 27. When the buttock plate 41, the thigh plate 42 and the calf plate 43 are laid flat, the first reinforcing rod 26 will abut against the buttock plate 41, the two first supporting rods 23 will abut against the thigh plate 42, and the three first top rods 48 will abut against the calf plate 43, realizing the support for the buttock plate 41, the thigh plate 42 and the calf plate 43. There are two mount grooves 431 on the calf plate 43, and a massager 49 is mounted in the two mount grooves 431. The massager 49 can massage the user's calf and improve the comfort of the user.

The buttock plate 41 is provided on a through slot 411. One set of the supporting mechanism 1 is mounted on the buttock plate 41, the two fixed frames 11 in the supporting mechanism 1 are fixed on the buttock plate 41, and the supporting plate 16 in the supporting mechanism 1 is slidably and penetratably provided in the through slot 411. When the piston rod of the first electric cylinder 17 extends out, the first electric cylinder 17 will drive the supporting plate 16 to move so as to abut against the user's buttocks, thereby supporting the user's buttocks and improving the user's comfort.

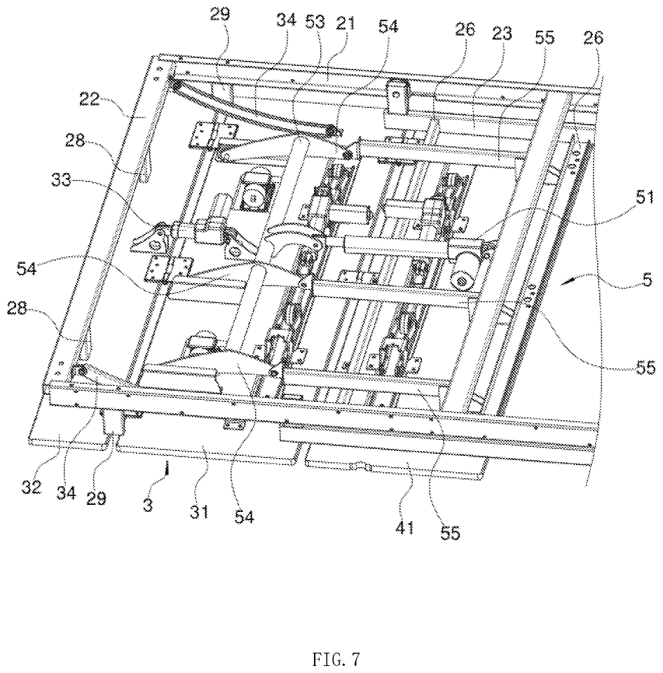

As shown in FIG. 7, the upper plate mechanism 3 includes a backplate 31, a headplate 32, and a third electric cylinder 33. The both ends of the back plate 31 are respectively rotatably connected to the buttock plate 41 and the head plate 32, and the both ends of the third electric cylinder 33 are respectively rotatably connected to the back plate 31 and the headplate 32. When the piston rod of the third electric cylinder 33 extends out, the third electric cylinder 33 itself will rotate and cause the headplate 32 to rotate relative to the backplate 31, adjusting the inclination angle of the headplate 32, and improving the user's comfort.

Two second top rods 28 are fixed on the longitudinal rod 22; and a third top rod 29 is fixed on the two horizontal plates 21. When the backplate 31 and the headplate 32 are laid flat, the two first supporting rods 23 will abut against the backplate 31, the two second top rods 28 will abut against the headplate 32, and the two third top rod 29 will abut against the backplate 31 and the headplate 32, thereby achieving the support for the backplate 31 and the headplate 32.

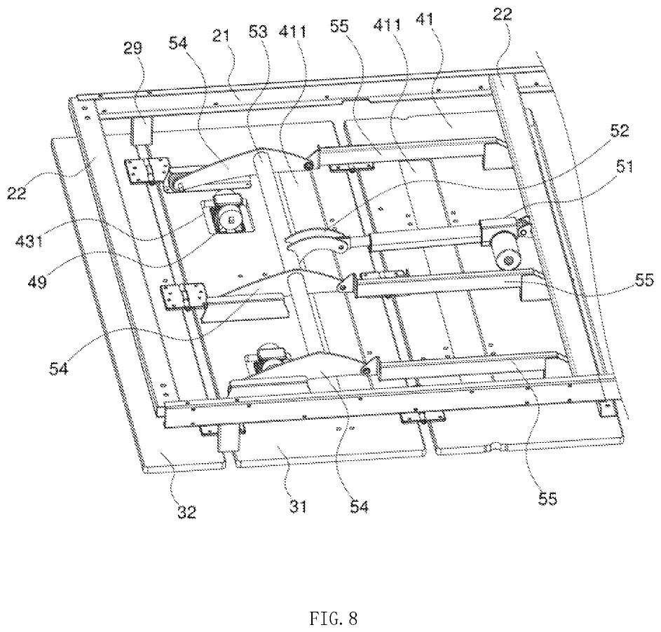

As shown in FIGS. 7 and 8, the backplate 31 is provided with a through slot 411. The other group of the supporting mechanism 1 is mounted on the backplate 31, and the two fixed frames 11 in the supporting mechanism 1 are both fixed on the backplate 31, and the supporting plate 16 in the supporting mechanism 1 is slidably and penetratably provided in the through slot 411. When the piston rod of the first electric cylinder 17 extends out, the first electric cylinder 17 will drive the supporting plate 16 to move so as to abut against the waist of the user, thereby supporting the waist of the user and improving the comfort of the user.

There are two mount grooves 431 on the backplate 31, and a massager 49 is mounted in the two mount grooves 431. The massager 49 can massage the user's back and improve the comfort of the user.

A telescopic mechanism 5 is provided on the backplate 31. The telescopic mechanism 5 includes a second electric cylinder 51. One end of the second electric cylinder 51 is rotatably connected to one of the longitudinal rods 22, and the other end of the second electric cylinder 51 is rotatably connected with the connecting frame 52. A penetration rod 53 extending in the horizontal direction is fixed on the connecting frame 52. Three pieces of rotatory plates 54 are penetratably provided on the penetration rod 53. One end of the rotatory plate 54 is rotatably connected to the backplate 31, and the other end of the rotatory plate 54 is rotatably connected with the third fixing rod 55 fixed on the buttock plate 41.

When the piston rod of the second electric cylinder 51 extends out, the second electric cylinder 51 itself will rotate and cause the connecting frame 52, the penetration rod 53 and the rotatory plate 54 to rotate, and the rotatory plate 54 causes the backplate 31 to rotate, adjusting the inclination angle of the backplate 31, so that the user can recline on the backplate 31 in different postures; meanwhile, the rotatory plate 54 limits the rotation of the backplate 31, so the stability of the backplate 31 during the rotation is improved.

As shown in FIG. 7, the backplate 31 is rotatably connected with the two second linkage plates 34, each of which is rotatably connected to one of the longitudinal rods 22. During the rotation of the backplate 31, the backplate 31 will drive the second linkage plate 34 to rotate, and the second linkage plate 34 will support the backplate 31 to improve the stability of the backplate 31.

The implementation principle of the electric bed frame of the present application is as below. During the use of the electric bed frame, the user's buttocks will sit on the buttock plate 41; when the piston rod of the second electric cylinder 51 extends out, the second electric cylinder 51 itself will rotate and cause the connecting frame 52 and the penetration rod 53 to rotate, and the penetration rod 53 will rotate the backplate 31 through the rotatory plate 54, thereby adjusting the inclination angle of the backplate 31.

When the piston rod of the third electric cylinder 33 extends out, the third electric cylinder 33 itself will rotate and cause the headplate 32 to rotate relative to the backplate 31 and adjusting the inclination angle of the headplate 32.

When the piston rod of the fourth electric cylinder 44 extends out, the fourth electric cylinder 44 itself will rotate and cause the thigh plate 42 to rotate relative to the buttock plate 41, the thigh plate 42 during the rotation will drive the calf plate 43 to rotate, and the calf plate 43 during the rotation will drive the first linkage plate 45 to rotate; the thigh plate 42 and the calf plate 43 will form an inverted V-shaped plate, the user's thigh rests on the thigh plate 42, and the user's calf rests on the calf plate 43, the junction of the thigh plate 42 and the calf plate 43 will abut against the user's the bend between the thigh and the calf.

When the piston rod of the first electric cylinder 17 extends out, the first electric cylinder 17 will drive the supporting plate 16 to move, and the two supporting plates 16 will abuts against the waist and buttocks of the user respectively, realizing the support for the waist and buttocks of the user.

In summary, the present application improves the comfort of a user.

The above are the preferred embodiments of the present application, and the scope of protection of the present application is not limited accordingly. Therefore, all equivalent changes made in accordance with the structure, shape and principle of the present application shall be covered by the scope of protection of the present application.

What is claimed is:

1. A supporting mechanism, characterized by comprising a first electric cylinder (17), a connecting rod (13), a supporting plate (16) and two fixed frames (11), wherein both ends of the first electric cylinder (17) are respectively rotatably connected to the connecting rod (13) and one of the fixed frames (11); the two fixed frames (11) each are rotatably connected with a rotatory frame (12), and the connecting rod (13) is connected to the two rotatory frames(12); the two rotatory frames (12) each are rotatably connected with a roller (14) and a linkage frame (15), the roller (14) abuts against the supporting plate (16), and the two linkage frames (15) each are respectively rotatably connected to the supporting plate (16); the rotation planes formed by the first electric cylinder (17), by the rotatory frame (12) and by the linkage frame (15) when rotating are parallel to each other.

2. An electric bed frame, characterized by comprising a bed frame body and at least one group of the supporting mechanism (1) as claimed in claim 1, wherein the fixed frame (11) is provided on the bed frame body, and a through slot (411) is provided on the bed frame body for the corresponding supporting plate (16) to slide through.

3. The electric bed frame according to claim 2, wherein the bed frame body includes a bed frame (2), an upper plate mechanism (3), a lower plate mechanism (4) and a telescopic mechanism (5); at least one group of the supporting mechanism (1) is provided on the upper plate mechanism (3), and the fixed frame (11) in the supporting mechanism (1) is mounted on the upper plate mechanism (3); at least one through slot (411) is provided on the upper plate mechanism (3), the upper plate mechanism (3) is rotatably connected to the lower plate mechanism (4), the lower plate mechanism (4) is provided on the bed frame (2), and both ends of the telescopic mechanism (5) are respectively rotatably connected to the bed frame (2) and the upper plate mechanism (3).

4. The electric bed frame according to claim 3, wherein the telescopic mechanism (5) comprises a second electric cylinder (51), a connecting frame (52), a penetration rod (53) and a rotatory plate (54); both ends of the second electric cylinder (51) are respectively rotatably connected to the bed frame (2) and the connecting frame (52), the connecting frame (52) is connected to the penetration rod (53), the penetration rod (53) extends in the horizontal direction through the rotatory plate (54), and both ends of the rotatory plate (54) are respectively rotatably connected to the bed frame (2) and the upper plate mechanism (3).

5. The electric bed frame according to claim 3, wherein the upper plate mechanism (3) comprises a backplate (31), a headplate (32) and a third electric cylinder (33); both ends of the backplate (31) are respectively rotatably connected to the lower plate mechanism (4) and the headplate (32), and both ends of the telescopic mechanism (5) are respectively rotatably connected to the bed frame (2) and the backplate (31); at least one through slot (411) is provided on the backplate (31), and both ends of the third electric cylinder (33) are respectively rotatably connected to the backplate (31) and the headplate (32).

6. The electric bed frame according to claim 3, wherein the lower plate mechanism (4) comprises a buttock plate (41), a leg plate unit and a fourth electric cylinder (44); both ends of the buttock plate (41) are respectively rotatably connected to the upper plate mechanism (3) and the leg plate unit, and both ends of the fourth electric cylinder (44) are respectively rotatably connected to the bed frame (2) and a leg plate unit.

7. The electric bed frame according to claim 6, wherein the leg plate unit comprises a thigh plate (42) and a calf plate (43); both ends of the thigh plate (42) are respectively rotatably connected to the buttock plate (41) and the calf plate (43), and both ends of the fourth electric cylinder (44) are respectively rotatably connected to the bed frame (2) and the thigh plate (42).

8. The electric bed frame according to claim 7, wherein the bed frame (2) and the calf plate (43) are rotatably connected with the first linkage plate (45).

9. The electric bed frame according to claim 3, wherein the at least one group of the supporting mechanism (1) is provided on the lower plate mechanism (4), and the lower plate mechanism (4) is further provided with a through slot (411).

10. The electric bed frame according to claim 2, wherein the bed frame body is provided with at least one mount groove (431), and a massager (48) is provided within the mount groove (431).
